(19) United States
(12) Patent Application Publication
(10) Pub. No.: US 2010/0280904 A1
(43) Pub. Date: Nov. 4, 2010

(54) Social marketing and networking tool with user matching and content broadcasting / receiving capabilities

(76) Inventor: Sumit Pradeep Ahuja, New York, NY (US)

Correspondence Address: Allan Chan & Associated, Suite 700, 225 Broadway, New York, NY, 10007, US

(21) Appl. No.: 12/799,704

(22) Filed: Apr. 30, 2010

Related U.S. Application Data
(60) Provisional application No. 61/215,089, filed on May 1, 2009.

(51) Int. Cl. G06Q 30/00; G06Q 99/00; G06F 15/16

(52) U.S. Cl. 705/14.58; 705/1.1; 709/204

(57) ABSTRACT

A proximity based social marketing tool/device that is free from a physical location and can be used for matching users and broadcasting messages or data to all or selected users in the proximity. These users can be searched by scanning the selected proximity range and/or by defining various keyword criteria's. And it utilizes one or more or a combination of various short-range or long-range wireless communication technologies such as Bluetooth, Wi-Fi, GPS, NFC, TransferJet, Internet, and others. The X-Path device can locate and store user's location details in the X-path server, which can be retrieved and used by users to broadcast messages to a specific category of an audience. It also makes for a great Social networking tool and takes the concept of Social Networking from the Internet out to the real Physical World.

### CLAIM OF PRIORITY

This patent application claims priority from provisional patent application Ser. No. 61/215,089, filed on May 1, 2009.

### FIELD OF INVENTION

The present invention relates to a system or a wireless electronic handheld communication device equipped with various wireless communication technologies that include, Bluetooth, Wi-Fi, GPS, NFC, TransferJet, 3G, 4G, etc and more particularly is directed towards the device's social marketing, social networking, broadcasting, and receiving data capability.

### DESCRIPTION OF RELATED ART

Displaying banners of products and services on billboards in the best localities of a town is an ancient but still very effective form of advertisement. In the past few years, marketing gurus did modify this concept and introduced Proximity Marketing wherein, ads and promotions are pushed to an individual's Bluetooth device (in the proximity of business). As the individual comes within the range of the Bluetooth transmitter of a particular business, shopping mall, movie theatre, or a club, the advertisement/promotion content is pushed to the individual's handheld Bluetooth device. The individual has the option to accept or reject the received message. Generally, the Bluetooth transmitter is capable of sending messages to a Bluetooth enabled device in the range of up to 30 meters. Displaying banners and proximity marketing are effective and widely used in many countries. Unfortunately, in both forms, the advertiser has to wait for the targeted individuals to approach them. In today's competitive environment, every lost opportunity to market a product or service can adversely affect the business. As the pros and cons of currently used proximity marketing tools are revealed, it is time to introduce a wireless handheld device/system equipped with various communication technologies, which enables various businesses to precisely reach their target users based on various criteria's as described further in this Patent document. The device is also capable of broadcasting and receiving messages in a user defined radius and hence create a virtual social market in a defined physical proximity of the user. Additionally, the device can be used to target defined audiences using various features as discussed in the document.

### BRIEF SUMMARY OF THE INVENTION

It is an object of the present invention to provide a system, method, or a device that uses various inbuilt short-range or long-range wireless communication technologies to scan and search for users using the search function, by specifying the proximity of target individuals; current location of the target users; or any location that they have visited in the past, etc. The device facilitates the feature of defining specific target audiences that match a combination of various criterions such as profile keywords, individual interests, physical proximity, current location, historic locations, etc The user can send a text, a multimedia message, video, audio or a combination of all to broadcast his/her message to the target audience. The device is capable of storing the individual's daily places of visit (Geo Tag) like bars, restaurants, airports, and other points of interests. This feature is termed as Geo-Tagging. This information is stored on the Server and can be used later to broadcast messages to all users who have visited a particular location in the past or are currently at any location of interest of the broadcasting user. A user can think of this device as proximity oriented “Virtual Craigslist”, which enables the user to create his own virtual marketplace by broadcasting messages (Sales, Need information, Event Invitation, Discount Coupon, Spare Ticket for Sale, etc) in a specified radius. A user can utilize the broadcasting feature by defining the proximity radius, current or historical location of the target audience, or by mentioning a certain criteria, or a combination of all. Based on the selected proximity radius, the device uses the appropriate short range (peer-to-peer) or long range wireless communication technologies or a combination of both to first perform the search and then interact with the users either directly, or via a communication medium, or any other systems that may be required to complete the process.

Additionally, the device serves the purpose of a social networking tool that allows its users to create more than one personal or professional profile, add the profile of their friends, and make the profile(s) available for other users in the proximity. The device presents the individual with various options to communicate that include text message, MMS, phone call, email, “Add as friend” (for Facebook, MySpace or any other Social Networking community), and others to interact with the users displayed in search results. The device is a handy tool to perform a “pro-active” search for individual profiles as per the defined search criteria and it alerts the user if the individual with the matched criteria is found in the vicinity. In addition, it is capable of exchanging personal contacts, business cards, individual or business profiles or any file or information by bringing two devices in contact with each other. This is possible by incorporating near-field communication technologies like Bluetooth, NFC and Transferjet.

Another feature of the device could be a built-in Twitter client enabling the user to “Tweet” promotional ads or put up his/her personal items up for sale.

Another unique feature of the device is its ability to automatically notify the user the presence of a common contact (friend's friend), in the defined proximity search radius. The device considers friends or connections stored in the phone book and added on various networking sites, Facebook, MySpace, etc as first degree friends. It utilizes the previously mentioned near-field communication technologies to search the presence of the first degree contacts. The user can perform this search automatically or manually by altering the proximity radius.

The device generates the “Word Cloud” based on the user's interest, location, friends, and other information entered by the user in the profile. The device also facilitates the user to add his/her preferred keywords in the Word Cloud. As two users of the device come in close proximity, the device automatically picks the common keywords from the Word Cloud section of the two users and notifies the users of the presence of another user with similar keywords, interests, or a common friend. Additionally, the user can turn off the automatic search feature and manually search for other users by specifying the desired keyword.

The device can also be set in the “Promiscuous Mode” wherein it is capable of receiving and storing Contact/Virtual Business cards from all users in the proximity (if other users have chosen to freely broadcast their selected Contact/Virtual Business Card). This eliminates the need for exchange and allows the free distribution of virtual business cards in conferences, board meeting, parties, and other places. The information is then stored in the temporary contact database and can be synched with the individual's in-built address book, Outlook or any other email client address book, or any other device based on user's discretion. The device's contact/profile exchange feature can also be used to exchange and sync an individual's Address, Contact details, MSN, ICQ, Yahoo, Skype, Twitter, YouTube, Website, MySpace, Facebook, Picasa or any other contact information either in promiscuous mode or during an user initiated contact exchange. A copy of all users' profile and contact information is stored on the XPath web server. Whenever a user makes any changes to his/her profile or contact information, the updates are automatically sent to every other user who has stored this user in the address book or on friends list. This is known as the Auto-Update feature.

Other parts of the present invention will be obvious and shall appear hereinafter.

The invention accordingly comprises the device and systems, together with their parts, elements and interrelationships that are exemplified in the following disclosure, the scope of which will be indicated in the appended claims.

A fuller understanding of the nature and objects of the present invention will become apparent upon consideration of the following detailed description taken in connection with the accompanying drawings, wherein:

### BRIEF DESCRIPTION OF THE DRAWINGS

FIG. 1 is an illustrative block diagram of a wireless handset for social marketing with social networking capabilities.

FIG. 2 is an illustrative block diagram of the perspective hardware components that could comprise the device.

FIG. 3 is an illustrative block diagram of the software architecture of the device/system.

FIG. 4 is an illustrative diagram of the GUI overview for the device.

FIG. 5 is an illustrative block diagram of various components and technologies that may be deployed for this system.

FIG. 5.1 is an illustrative flow chart describing the steps involved for scanning users in the vicinity using different search radius.

FIG. 6 is an illustrative diagram displaying the search for common contacts.

FIG. 7 is an illustrative diagram of the GUI displaying the various user profiles in the vicinity.

FIG. 8 is an illustrative diagram of the GUI displaying a detailed view of the selected individual's profile data.

FIG. 9 is an illustrative flow chart showing how the user would broadcast a message and define his target audience based on physical proximity, demographics etc.

FIG. 10 is an illustrative flow chart describing steps involved to set various user profiles in the system.

FIG. 11 is an illustrative flow chart for scanning and searching users in the selected scan radius area using the default search criteria.

FIG. 12 is an illustrative flow chart for scanning and searching users in the selected scan radius area using a custom search criterion, which can be described as searching for users classified of a particular category or specifying the required keywords. For instance, business personnel, musicians, technicians, people belonging to a certain age group, and others.

FIG. 13 is an illustrative flow chart for searching for users based on Word-Cloud matches.

FIG. 14 is an illustrative flowchart for the user performing pro-active user searches according to the specified search criterion.

FIG. 15 is an illustrative flow chart for scanning and searching users in the selected scan radius from the list of contacts in the phone book or friends listed in various networking sites.

FIG. 16 is an illustrative flow chart for exchanging contacts, profile data, and any other information between two devices using NFC.

FIG. 17 is an illustrative flow chart describing the device operation in the promiscuous mode.

FIG. 18 is an illustrative flow chart for accepting requests or messages from users as per the defined match criterion.

FIG. 19 is an illustrative flow chart for leaving a call-back message in the event of no response.

FIG. 20 is an illustrative flow chart for configuring the device via the X-path web server using an alternative system or a device.

FIG. 21 is an illustrative flow chart to sync the friend's list in the device with one or more social networking websites using the Internet.

FIG. 22 is an illustrative flow chart to sync the friend's list in the device with MS Outlook or any other contact management programs.

FIG. 23 is an illustrative flow chart to auto update the contact list or profile data and friends list.

FIG. 24 is an illustrative flow chart for broadcasting an advertisement in the selected scan radius area using the X-path server or the wireless server.

FIG. 25 is an illustrative flow chart for displaying internet search results and advertisements as per the entered keyword.

FIG. 26 is an illustrative flow chart for Geo Tagging various venues and sharing this information with online social networking sites on the Internet.

### DESCRIPTION OF THE PREFERRED EMBODIMENT

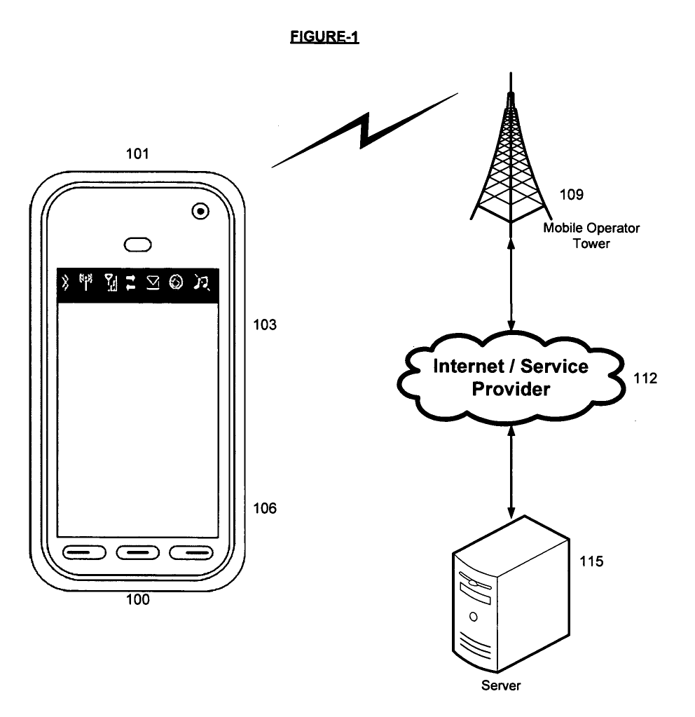

Referring now to the diagrams, FIG. 1 displays a wireless communication system between a wireless handheld device, mobile phone handset 100, the mobile operator tower 109, Internet cloud 112 and a web server 115. The wireless handheld device is not just confined to a mobile handset but can be a pager, a Personal Digital Assistant (PDA), touch screen device with or without haptic capabilities, a portable computer, tablet computer, a notebook, or a device that comprises of all features of devices mentioned before as known to persons skilled in the art. The handset 100 is capable of accepting data, transferring data to other users using various wireless and wired technologies, WLAN(802.11), GSM, 2G, 3G, GPRS, Bluetooth, Infrared, Near-field communication, Transferjet, HSPA, HSUPA, HSDPA, CDMA, UMTS, WiMAX, WiBro, 4G or any other wireless communication network or system known to persons skilled in the art. The wireless access node 101 of the handset 100 that withholds various wireless communications technologies 109 is coupled with a wired network 112 such as the Internet or a Service Provider network. The device and the communication technologies are linked to access information and applications residing on various servers present anywhere around the globe, such as server 115. The server 115 may provide content that may be shown on display 103 or may be able to transfer an executable code to handset 100, which the handset 100 may execute to perform specific operations or may execute specific functions on behalf of the handset. Alternatively, a user may access the wireless device or X-Path network through a web portal, website, internet access terminal or computer.

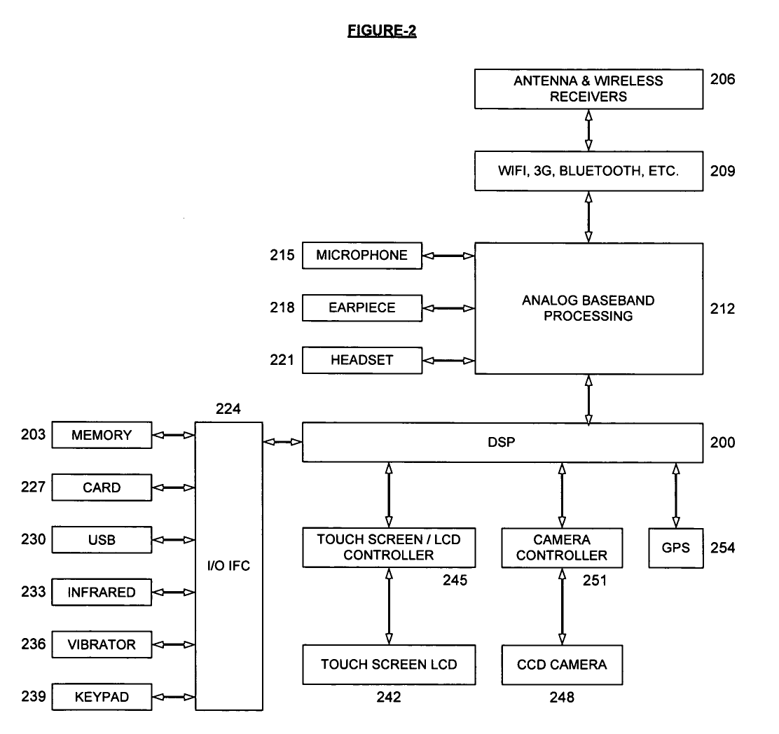

FIG. 2 displays the internal hardware communication system for the handset 100. The digital signal processor (DSP) 200 of the handset 100 acts as central processing unit that controls its various components in accordance with embedded software or firmware stored in the memory 203. In addition, DSP 200 executes other applications stored in memory 203 or made available via information carrier media such as portable data storage media like the removable memory card 227 or via wired or wireless network communications. The antenna and front-end unit 206 convert between wireless signals and electrical signals, which enables the handset to send and receive information from a wireless network. The RF transceiver 209 provides frequency shifting; converting received RF signals to baseband and converting baseband transmit signals to RF. The analog baseband processing unit 212 may provide channel equalization and signal demodulation to extract information from received signals, may modulate information to create transmit signals, and may provide analog filtering for audio signals. To that end, the analog baseband processing unit 212 may have ports to connect to the built-in microphone 215 and the earpiece speaker 218 that enable the handset 100 to be used as a cell phone. The analog baseband processing unit 212 may further include a port for connecting to a headset or other hands-free microphone and speaker configuration. The DSP 200 may send and receive digital communications with a wireless network via the analog baseband processing unit 212. In some embodiments, these digital communications may provide Internet connectivity, enabling the user to gain access to content on the Internet and to send or receive email or text messages among other communications. The input/output interface 224 interconnects the DSP 200 and various memories and interfaces. The memory 203 and the removable memory card 227 may provide software and data to configure the operation of the DSP 200. Among the interfaces may be the USB interface 230 and the infrared port 233. The USB interface 230 may enable the handset 100 to function as a peripheral device to exchange information with a personal computer or other computer system or application. The infrared port 233 or other ports such as Bluetooth interface or an IEEE compliant 802.11 wireless interface or any other wireless communication technology such as NFC, TransferJet, GSM, 2G, 3G, GPRS, 4G, HSPA, HSUPA, HSDPA, CDMA, UMTS, WiMAX, WiBro etc may enable the handset 100 to communicate wirelessly with other nearby handset and/or wireless base stations. The input/output interface 224 may further connect the DSP 200 to the vibrator 236 that, when triggered, causes the handset 100 to vibrate. The vibrator 236 may serve as a mechanism for silently alerting the user to any of the various events such as incoming call, a new text message, and appointment reminder or for any other event etc. The keypad 239 couples to the DSP 200 via the interface 224 to provide one mechanism for the user to make selections, enter information, and otherwise provide input to the handset 100. Another input mechanism may be the touch-screen LCD 242, which may also display text and/or graphics to the user. The touch-screen LCD controller 245 couples the DSP 200 to the touch-screen LCD 242. The CCD camera 248 enables the handset 100 to take digital pictures. The DSP 200 communicates with the CCD camera 248 via the camera controller 251. The GPS sensor 254 is coupled to the DSP 200 to decode global positioning system signals, thereby enabling the handset 100 to determine its position. Various other peripherals may also be included to provide additional functions, e.g. accelerometers, haptic module and drop sensors.

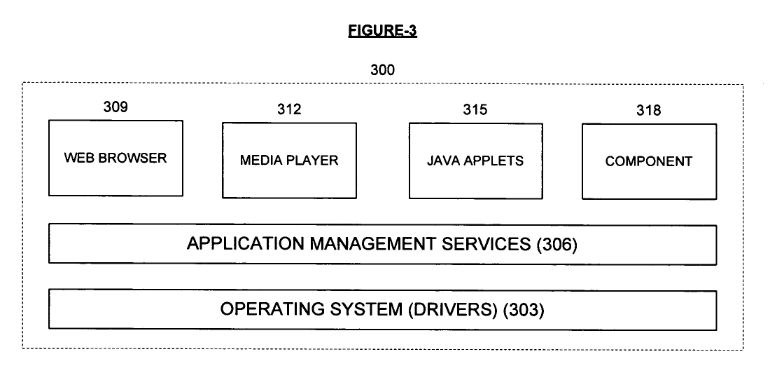

FIG. 3 illustrates a software environment 300 that may be implemented by DSP 200. The DSP 200 executes operating system drivers 303 that provide a platform for operating various Softwares. The operating system drivers 303 provide drivers for the handset hardware with standardized interfaces that are accessible to application software. The operating system drivers 303 include application management services (AMS) 306 to transfer control between applications running on the handset 100. Also shown in FIG. 3 are a web browser application 309, a media player applications 312, and Java applets 315. The web browser application 309 configures the handset 100 to operate as a web browser, allowing a user to enter information into forms and select link to retrieve and view web pages. The media player application 312 configures the handset 100 to retrieve and play audio and/or audiovisual media. The Java applets 315 configure the handset 100 to provide games, utilities, and other functionalities. A component 318 may provide for a functionality to add more software components to the handset 100.

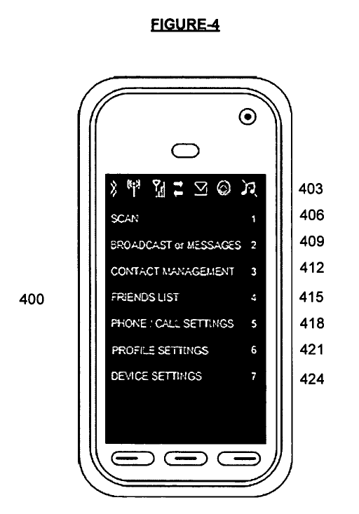

FIG. 4 represents an illustration for the Graphical User Interface (GUI) of the device 100. This diagram represents one of the methods in which the GUI could be arranged on the said device 100. The GUI is coupled with the functionality of the LCD touch-screen 400 to provide a touch interface for the system. The Status Bar 403 displays various symbols indicating current activity, alerts, system status etc. The Status Bar 403 presents the user with symbols of active connections, active profiles, signal strength, battery level, new messages, the mode in which the device is operating, and others. Scan 406 represents the Proximity Scan button, which provides the user with various options to scan for other users in the vicinity based on the settings selected by the user. Messages 409 enables users to manage messages that include instant messages (IMs), SMS, MMS, emails, Bluetooth messages, broadcast messages sent by an authorized system, advertising messages, and others. Contact Management 412 enables the user to manage various contact lists, synchronize contacts with various other devices, and manage all business and private visiting cards. In addition, users can auto-update the information of the various contacts and business cards and allow them to sync contacts with other devices and programs such as but not limited to Outlook, iCal etc. Using the contact management feature a user can exchange contact information with other users using one or more of the communication technologies built in the system. Friends List 415 enables the user to manage friends from various networking sites, send and accept friend requests, add friends to contacts, and synchronize the friends list on the device with the friends list on networking sites. This function even enables users to post a message and auto-update any information on its contact profiles. The Phone/Call Settings 418 enable the user to configure the inbuilt phone that is built into the system. Profile Setting 421 enables the user to configure various user profiles that include social, business, public, or private profiles. In addition, it allows users to enter profile data and set a profile as an active Profile. Device Configuration 424 enables the user to configure the various options for the audio, visual, look, feel, alerts etc of the system. These options and settings for all functions are discussed in detail ahead in this patent.

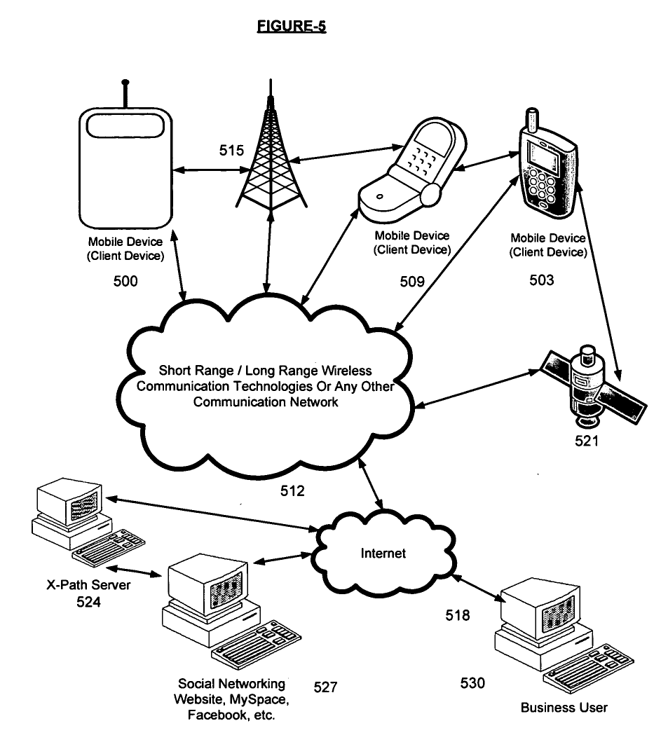

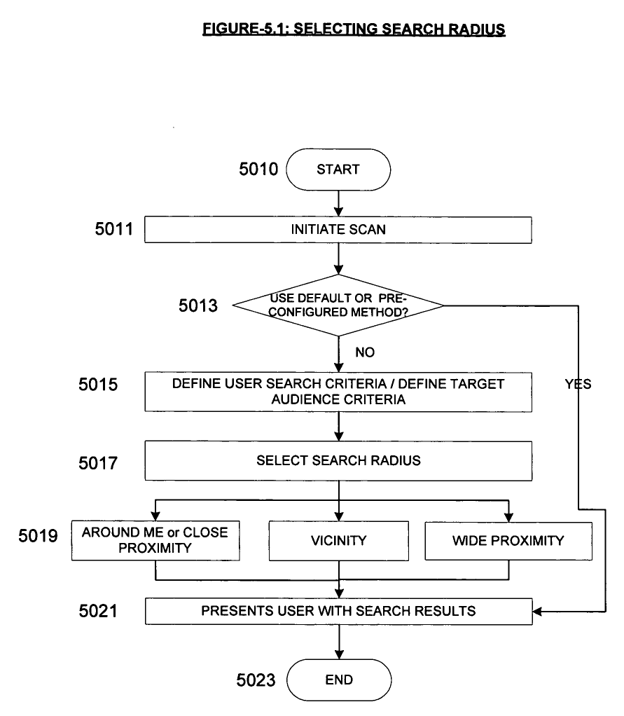

FIG. 5 explains the working environment for the said system and illustrates various essential communication technologies to perform a range of functionalities in the system. A user can install the X-path software on a mobile device 500, 503, or 509 or have an independent X-path device. The devices may have a host of inbuilt short range communication technologies such as, WiFi, Bluetooth, WiMax, RF, infrared or NFC and Long Range communication technologies such as, Wifi, 3G, 4G, GPRS, LTE, Wimax, etc 512.

Short and Long range wireless communication technologies, or any other communication network 512 are used to first search for the target audience in parallel with the XPath server and then establish communication between devices (peer-to-peer) or between the devices and the system (Database server, XPath Server 524, Social Networking site server 527) spread over in small or large radius. A communication tower 515 is illustrated to represent the receptacles for such types of communication, which can be used for connecting to Internet 518, Internet supported systems, carrier network, and others. A GPS satellite 521 provides the information required for the device to perform various other functions that include Geo-tagging, navigation, location-based services such as advertising, locating users during scan for social networking, and others. The X-Path server and various social networking websites make use of the Internet cloud to communicate with various client devices for exchanging, updating, syncing, and displaying profile information. Additionally, a business user 530 is connected with the XPath server and utilizes the Internet to upload the advertisements.

The scan for users can be performed in three different categories (levels of search radius) that include Scan for user in close proximity (Around Me) or broader proximity (Vicinity or Wide).

Scan for users in Close Physical Proximity (Around Me): In FIG. 5, the device utilizes Bluetooth, WiFi, GPS, RF, Infrared and or any other satellite positioning service tool, with or without assistance from the X-Path server to first locate and then communicate with other devices 500, 503, or 512 in close physical proximity of the user. This search method is useful for locating users in close physical proximity such as in a bar, club, coffee shop, airplane, train, subway, restaurant, and others.

Scan for users in the Broader Proximity (Vicinity or Wide): In FIG. 5, the device employs cell triangulation and/or/in conjunction with GPS 521 or AGPS alongside a data access method which could be any short-range or long-range wireless communication technology (Wifi, 3G etc), or a satellite positioning technology, with or without assistance from the X-Path server to first locate and then communicate with users in this proximity range. This search method is extremely useful to locate users in the vicinity, and thinly populated areas. Additionally, a user can locate other users that belong to a specific category using this scan feature. A combination of various communication technologies with/without utilizing GPS can be used to perform this type of search. In Cell triangulation, the mobile handset's carrier network is employed to search and locate the user. In addition, the user profiles can be retrieved from the X-path server 524 on the carrier network or on the Internet, which is synced with the profile and settings on the user handheld device 100 (FIG. 1).

Defining the search radius: The device permits every user to define their own scan radius (Within 20 meters to xxx miles). The deployment of available communication technologies to first locate and then communicate with other users depends on the specified radius and available communication channels between the devices and the systems involved. As mentioned above.

FIG. 5.1 is an illustrative flow chart describing various steps involved for scanning users in the vicinity. The user initiates the scan 5011 and the device checks 5013 if the user has pre-defined search criteria. If yes, the device presents the search results 5021 and if otherwise, the device gives the option to define user search criteria or target audience criteria 5015. Then the user needs to select the search radius 5017 (Around Me or Proximity, Vicinity, or Wide Proximity 5019). Depending on the search radius, the device automatically selects the appropriate wireless communication technology; scans the available users in the defined geographical location and displays search results 5021. The displayed search result enables the user to select required profiles for further communication.

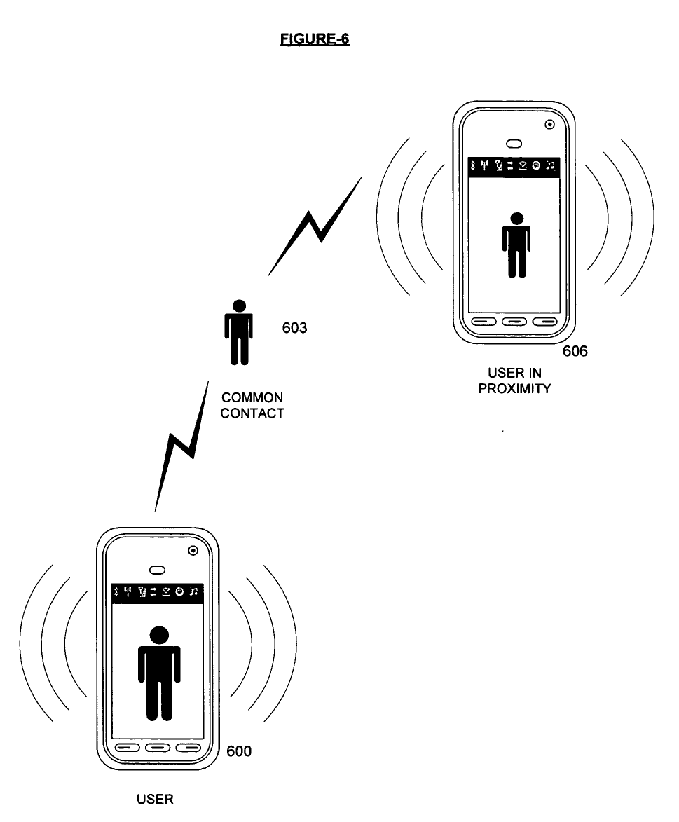

FIG. 6 is an illustration for searching first degree friends or contacts. The device considers a common contact between two users as the first degree contact. The objective of this concept is to ensure two strangers present in a certain radius are aware about the relationship between them (connected through a common contact 603). The user's X-path device 600 scans the defined radius and searches for the presence of a user in proximity 606 and compares the phone address book, friend's list of various social networking sites, and alerts the two users if a common contact is found. Additionally, it presents them with various options to communicate or ignore the found user. The comparison of the address books and friends list to find a common contact between the two users can be done on the Xpath servers as well for security reasons. The user can also exclude certain contacts from being searched for as a common contact.

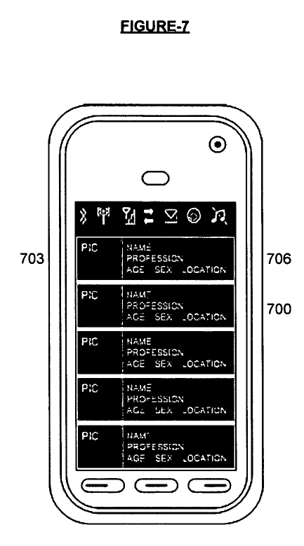

FIG. 7 is the GUI representation 700 of the various users found based on the scan performed by the user. The results display the profile picture 703 and other mandatory details 706 that include, name, profession, status message, age, sex, and location. As the user selects a particular user profile from the search results, the device enlarges it to a detailed profile (public) 800 and presents various communication options as discussed ahead.

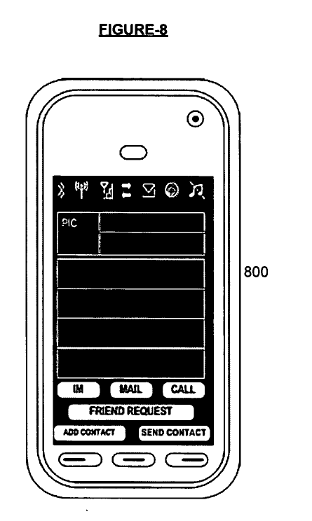

FIG. 8 is the GUI representation of a detailed public profile 800. The profile displays a profile picture and data fields of the active profile. The user is presented with various options to communicate with the displayed profile user that include but not limited to IM's, emails, phone call, send friend request, add to contact, send contact information, send profile info, and others.

Instant Messaging (IM): The methodology deployed by the device for sending IM's to other users depend on the physical distance between users.
Users in Close Proximity: When in close proximity and a direct communication link either via WiFi, Bluetooth or similar technology can be established then IM's can be sent direct without the use of a carrier network 512.
Users in Greater Physical Distance: When two or more users are separated by a greater physical distance, then IM's can be exchanged using a carrier network via the X-path server 524 between users.

SMS/MMS: Users that have exchanged contact details and added each other to their contacts or friends-list can exchange information and communicate by sending SMS/MMS. If two devices can establish a direct communication link, users can exchange SMS/MMS without utilizing the carrier network services. In case, a direct communication between the two devices cannot be established, carrier network is used to send SMS/MMS via the X-Path server.

E-mail: Users that have added each other to their friends list, and exchanged profiles can communicate by sending emails.

Making a Call: This device enables the user to call another user, when he/she is added as a contact and/or accepted as a friend. In case when two devices are in close proximity, the two devices can establish a direct link and the phone call between the two users can be placed without traversing the carrier network. In case of users separated by large physical distance, calls between them are routed over the carrier network (WiFi, Wimax, 3G, 4G, and others) or via the X-Path server. The device enables the VoIP deployment which allows the devices to initiate voice calls over short-range or long-range communication technologies.

Accept Add Friend Request: As a user locates another active user in the scan result, the device presents the user with a public profile and limited options to send IM's and send a Friend Request to communicate with the displayed user. As the user 1 sends a friend request to User 2, the device alerts user 2 in form of a ringer or a vibration and displays a pending friend request notification on the screen. If User 2 accepts the friend request, both users are added in each other's friend's list. The two users can exchange their respective public or private or an active profile data fields. Furthermore, if the two users Active profile displays links of their accounts with similar networking sites, MySpace, Facebook, and others, the device automatically sends “Friend Request” related to those Social Networking sites as well.

Add to contacts: This device enables this feature between the two users already added as friends. As User 1 sends an Add to Contact request to User 2, the device notifies user 2 in the way of a ring or vibrating alert. Once User 2 accepts the Add to Contact request, the device exchanges personal contact information, Home phone numbers, Cell phone numbers, Office Phone Numbers, Office address, Home address, and other personal information to be added to the address books.

Send contact: The device enables users to send contact information, business card, address book entry or profile details to any another X-Path user. In case, two users are strangers or not added as friends, the device restricts the exchange of contact information of other contacts and friends listed in the profile. In case, two users are accepted as friends by each other, the device enables exchange of contact information, address book entries, business card, or any data between the two users. The device could use various near field technologies such as NFC, and others, which enable data exchange by mere getting two devices in contact with each other for this purpose.

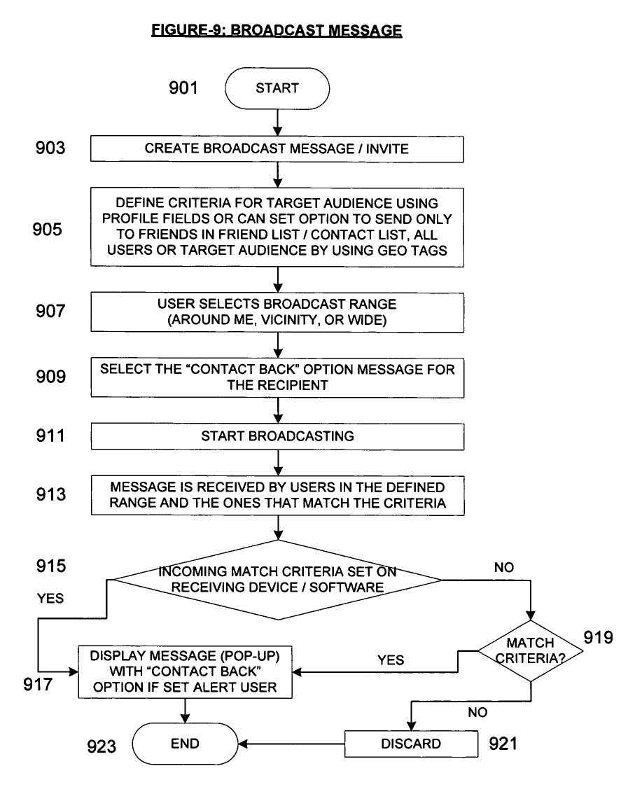

In FIG. 9, user A prepares the message to be broadcasted 903 and defines the target audience criteria 905 from various options that include, all available users Around Me, all users in contact lists, all friends in Friend list, all users currently at a particular location, all users who have visited a particular location, all users who frequently visit the specified location or by matching keyword and interests of target users. In case of targeting business users, the user can be targeted based on a wide range of criteria's; such as Salary, age, sex, work experience, profession, work location, willing to travel, married, car owner, is he/she a commuter etc. (this form of targeting the users could be very useful for finding a potential candidate for a job opening). The next step is to define the broadcast range 907 (Around Me, Vicinity radius, or a Wide radius). The device then sends all this information to the X-Path server, which in turn performs the user filtering and searches for all matching users in the selected radius based on the profile information of all the users stored on the server and also based on the current location of the users based on GPS data, it then forwards the broadcast message to all the matched users. Furthermore, the user can select a contact back option 909 in the broadcasted message, which enables the recipient to contact the broadcasting user using the selected method (SMS, email, IM, phone, and others). As the device broadcasts messages 911, by sending the relevant information to the X-path server, and if the device at the recipient's end can receive all messages, the broadcasted message is delivered in the recipient user's inbox, and it displays the user contact back option. In case, a receive message criteria is defined 915, the received message is validated against the criteria, if matched, the message is delivered to the recipient and the user contact back option is displayed. Else, the device discards the broadcasted message 921.

For example (Commercial use):
A merchant could target the audience as mentioned above and broadcast a promotional message to the targeted audience that requires the receiving users to complete a certain task before they get the promotional discount at a store or for a certain item.
A merchant could target the audience as mentioned above and broadcast a promotional message to the targeted audience that requires the receiving users to purchase a certain item or to shop at a particular store before the offer expires to receive the said offer.
A merchant could target the audience as mentioned above and broadcast a promotional message to the targeted audience about a loss-leader merchandise.
A merchant could target the audience as mentioned above and broadcast a promotional message to the targeted audience that requires the receiving users to complete a questionnaire or survey in order to receive the discount offer.
A merchant could target the audience as mentioned above and broadcast a message to the targeted audience that is a Job Posting or an Open Position within the organization.

For Example (Personal use):
A user could define his/her target audience by any of the methods mentioned above and could post a personal item for sale.
A user could target the audience as mentioned above and broadcast his/her business card or resume to the target audience. This could be very useful and practical at conferences, seminars and job fairs.

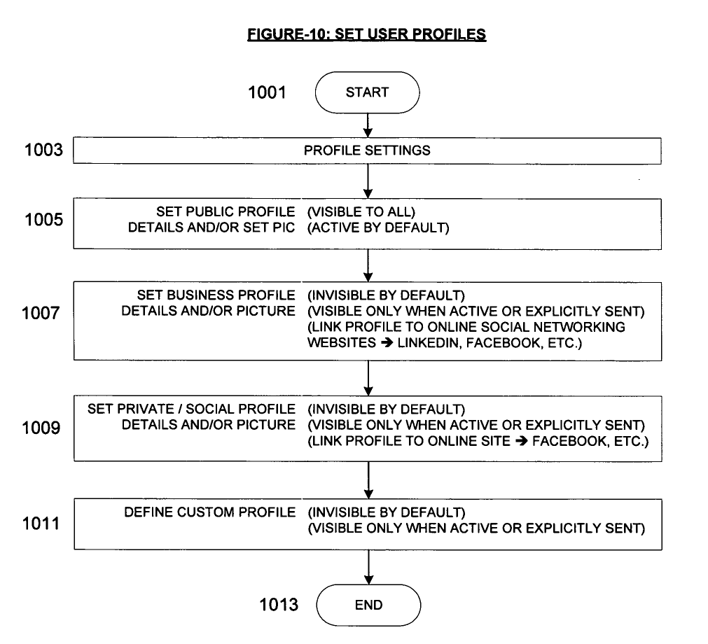

FIG. 10 is an illustrative flow chart describing steps involved to set various user profiles in the system. In this illustration, the user is assigned the authority to alter system defined profiles or create new ones. A profile can be altered or created by using the User Profile Settings function.

User Profiles are an integral operational part of the system. It is important to explain the working of various profiles to understand the features of the system. There are different kinds of profile and below is a brief description for each of them.

Public Profile 1005 is the default profile and the most permissive of all profiles. The profile displays the most basic user information and contains the least amount of personal user information.

Business Profile 1007 is an optional profile. The other users can only view the Public Profile by default unless the Business Profile has been set as the Active Profile. In the active state, the user can define the degree of profile information (details and picture) to be displayed to other users in a search result. Also, the user can link the profile to various social business networking sites such as Linkedin, and others.

Private Social Profile 1009 is similar to the Business Profile. The other users can only view the Public Profile by default unless the Private Social Profile has been set as the Active Profile. In the active state, the user can define the degree of profile information (details and picture) to be displayed to other users in a search result. Also the user can link the profile to various social networking sites that include Facebook, MySpace, Orkut, etc.

Users can set any one of the profiles as an Active profile, which then becomes the default profile for display to users in the vicinity. This feature is especially useful when the user is at a specific social setting, such as a Business Conference or at a Bar. In each of the listed examples the user may need a different profile to be displayed to other users in the vicinity.

User Created Profile can be termed as a profile created and customized by a user 1013. Every user can create their own profile from scratch by selecting or defining the profile data fields to be listed or displayed, within this profile each selected profile data field can be set to Public or Private. If set to active, only the Public data fields are displayed to other users and only after the user has accepted the friend request and established communication with the other user is the private data fields displayed. This is also the default behavior with Public, Business and Private Profile settings.

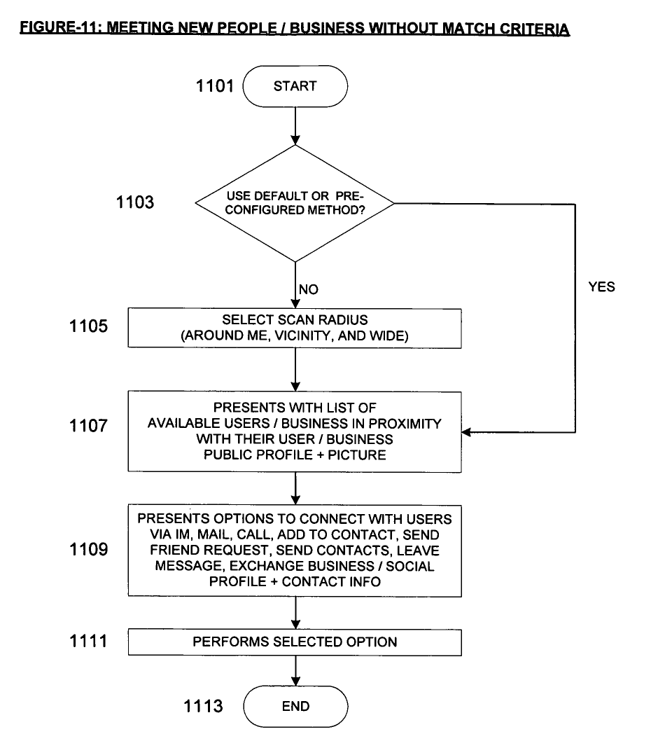

In FIG. 11, as the user initiates a search 1101, the device checks if the user has pre-configured the search method and criteria 1103. If yes, the system performs the search and the device displays all available users in the selected scanned area 1107. If otherwise, the user needs to select the scan radius 1105 and then the device displays the public or active profiles of all available users and businesses in the selected scanned area 1107. The device also presents the user with various options to connect 1109 with users in the search results. The options include IM, mail, add to contact, send friend request, send contacts, leave message, exchange business/local profile and contact information, etc. In the end, the device performs the selected option 1111.

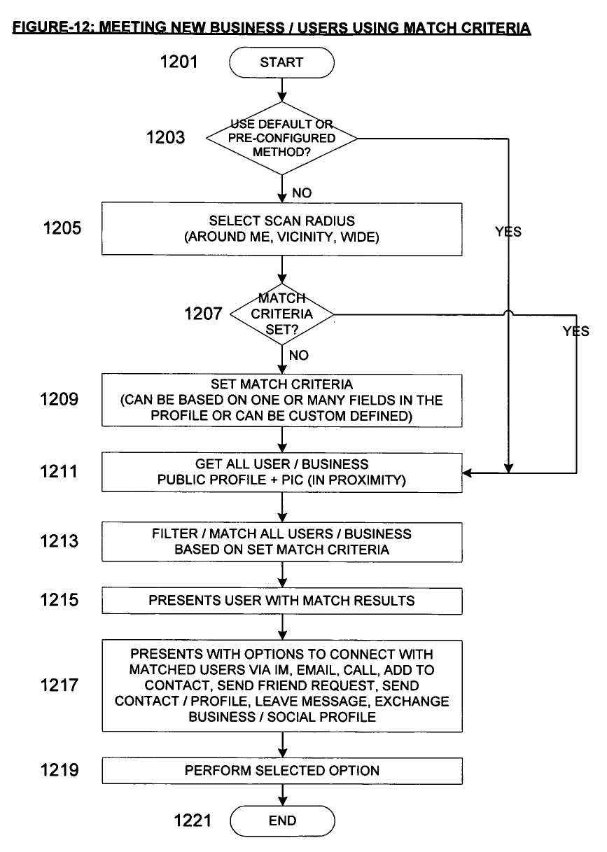

In FIG. 12, as the user initiates a search 1201, the device checks if the user has pre-configured the search method and criteria 1203. If yes, the device performs the search and displays all available users in the selected scanned area 1211, if otherwise, the device scans the radius 1205 and verifies if the user has set match criteria 1207. If yes, the device then polls the public or active profiles of all available users and businesses in the selected scanned radius 1211 and filters 1213 the search results based on the match criteria and then presents the user with the matched results. If the match criterion is not defined, the device gives the user an option to define or set a match criterion 1209 before proceeding to step 1215. The device then presents the user with various options to connect 1217 with users in the matched search results. The options include IM, mail, add to contact, send friend request, send contacts, leave message, exchange business/local profile and contact information, etc. In the end, the device performs the selected option 1219.

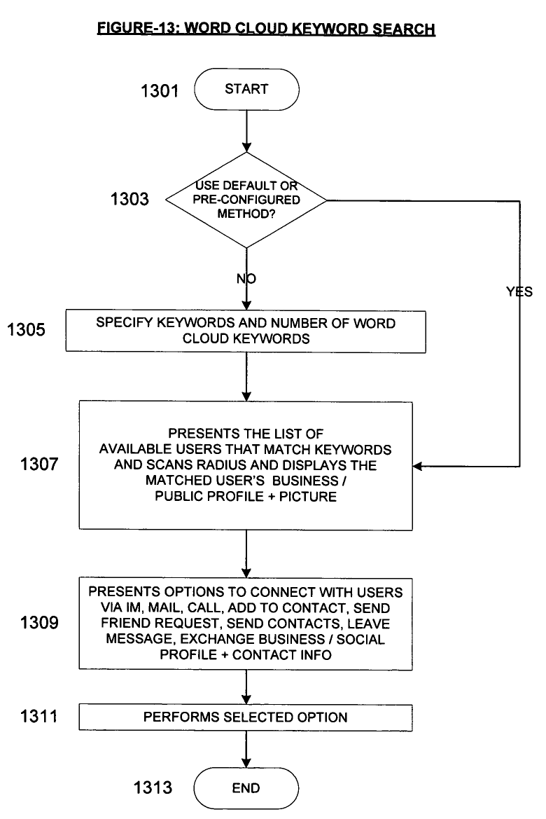

In FIG. 13, as the user initiates a search 1301, the device checks if the user has pre-configured the search method and criteria 1303. If yes, the device performs the search and displays all available users as per the default criteria 1307. If otherwise, the user needs to specify 1305 the keywords and the number of word cloud keywords to be considered while displaying the search result. Then the device displays the public or active business profiles of all available users that match the specified keywords 1307.

The device then presents the user with various options to connect 1309 with users in the matched search results. The options include IM, mail, add to contact, send friend request, send contacts, leave message, exchange business/local profile and contact information, etc. In the end, the device performs the selected option 1311.

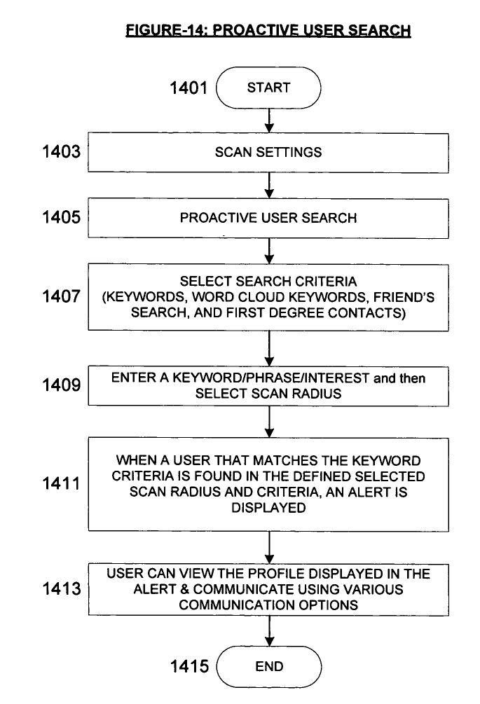

In FIG. 14, the device enables the user to perform the pro-active user search by specifying a distinct search criterion. This is a form of a “constant-on” search, where the device is always on the lookout for a matching profile in the defined Scan Radius. In the Scan Settings menu 1403, the user can select the proactive search option 1405 and mention the all or one of the following search criteria
1. Word Cloud keywords 1407, wherein the user can define the number of keywords to be matched while searching and displaying the required result.
2. Keywords that include profile details (sex, age, location, interests, Geo-Tag, and others) 1409, current location, historic location or a combination of all.
3. Friend's search, first and second degree contacts.

As a user that matches the specified criteria, the device alerts the user 1411 and displays public or private profile data of the search results in a graphical manner and also various communication options to initiate a conversation 1413.

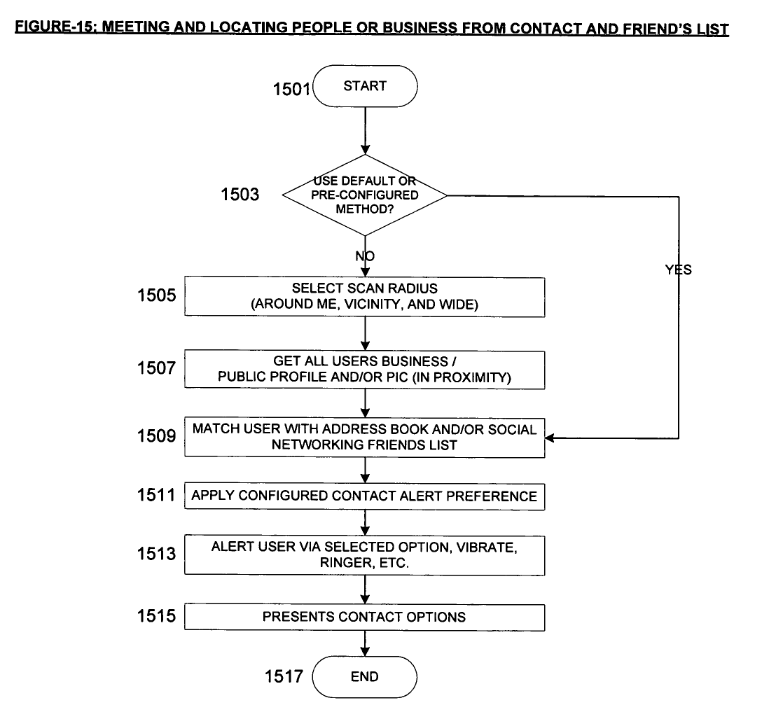

In FIG. 15, as the user initiates a search 1501, the device checks if checks if the user has pre-configured the search method and criteria 1503. If yes, the device performs the search and polls all users and business profiles in the defined Scan Radius and matches all available users/businesses with the address book, and the friends-list of all configured social networking websites 1509 if a match is found the device then alerts the user and presents with the list of all matched users, If otherwise, the user needs to select the scan radius 1505. The device then performs the search and polls all users and business profiles in the defined Scan Radius and matches all available users/businesses with the address book, and friends-list from all configured social networking websites 1509 if a match is found the device then alerts the user and presents with the list of all matched users 1509. The device also enables the user to apply a configured alert preference that includes ringtone, vibration alert, etc. for a contact 1511; then alerts the user with the selected preference 1513, and presents various contact back option 1515.

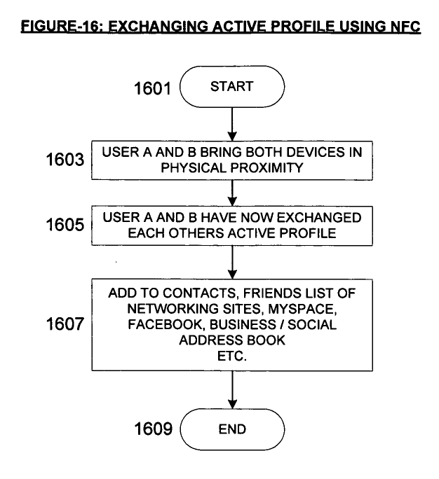

In FIG. 16, as two users A and B, get their respective devices in contact 1603, profile data, contact information or any other selected information is exchanged between the two devices using NFC 1605. The device stores the received information in an accessible location and enables the user to add the profile information to contacts, business address book, and in friends list of various networking sites 1607.

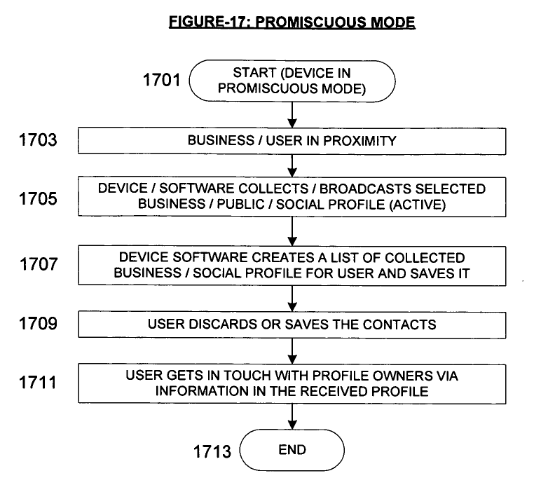

FIG. 17 explains the working of the device while set in Promiscuous mode, which enables the user to scan the defined proximity 1703 and collect the visible profile data of all active users in the proximity 1705. The device automatically stores the collected profile data in an accessible location 1707 and the user has the option to save, discard or contact the stored profile owners 1709. Additionally, user has the option to contact back the profile owners with the information received in the profile 1711.

Note: It is required for other users to opt for broadcasting their business/contact cards to all in the proximity for others in the Promiscuous Mode to receive the profile/business cards. In other words, users have to explicitly enable the broadcasting of their profile/business cards for other users in Promiscuous Mode to receive it.

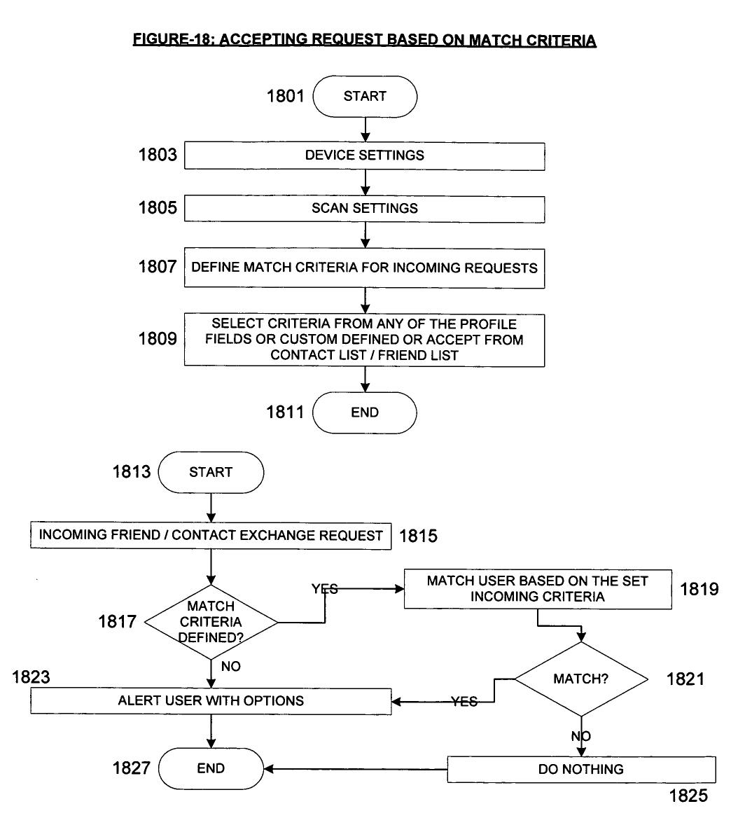

In FIG. 18, the device enables the user to be selective about any incoming friend requests from other users. For instance, in a music conference, the user intends to receive messages, friends request and/or communication only from other musicians. The device enables every user to define incoming request scan criteria from the Scan Settings option. The device presents the user with similar options for treating an incoming friend request through a match criterion.

In FIG. 18, the user selects the device settings option 1803, then the scan settings option 1805 and then defines the incoming requests match criteria 1807. In addition, the user has the option to select the criteria from a profile field or define criteria as per the friends list 1809. As the user receives an incoming messages, friend request etc from a new user in proximity 1815, the device then matches the incoming user with the defined match criteria 1817. If there is a match, the device presents the user with options to contact back the request sender 1823. In case, request does not match the set criteria, the device does not respond to the request 1825.

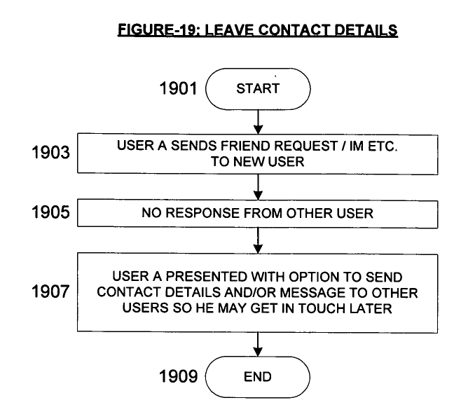

In FIG. 19, when a user sends a friend request 1903 to a user in proximity and in case there is no response 1905, the device presents the requesting user an option to send messages and other contact details so the non-responsive user can get back in touch in the future 1907.

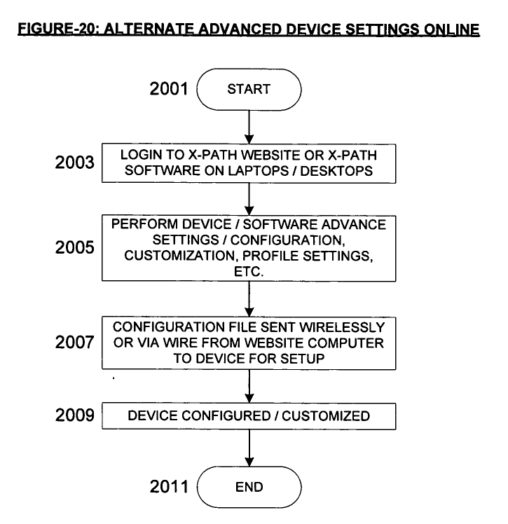

In FIG. 20, as a user logins to the X-Path website or the X-Path software on a device 2003, user can configure the device, alter the device settings, create or modify profile settings, and perform other device related alterations 2005. The user can then push the modified settings to the device through a wireless or wired technology and configure the device with the amended settings 2007. This ensures the device is configured and customized 2009 as per the user's requirement and provides with the ease of configuration.

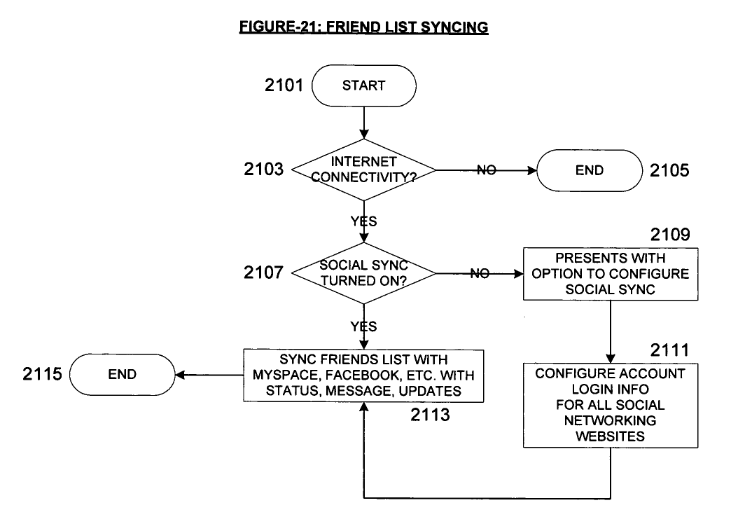

In FIG. 21, the user syncs the contacts and friends list with various social networking websites. This feature basically helps the user to establish and maintain contact with other users he/she has met in the real world by adding them as “friends” by sending them a friend request on the popular social networking websites via the emails addresses gathered from the user profile information. The first step for the device is to check the presence of an interne connection 2103. In case the user has turned on the social syncing option 2107, the device adds new friends in the friends list of the device as friends on various Social Networking sites such as Facebook and MySpace 2113. Else, the device presents the user with an option to configure and define the social sync criteria with networking sites 2109. Then the device configures the account information for all social networking websites, and syncs the friend list with the ones in social networking sites 2113.

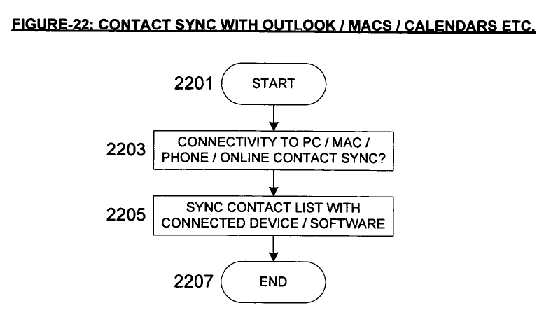

In FIG. 22, the user connects to a PC, MAC machine, phone, online contact address box 2203, and syncs reminders, meeting details, Address Book and other related information with MS outlook or other contact management software 2205, this can be achieved using a wired or a wireless technology. The main purpose of this feature is to sync address books and friends list with other phone books and calendars that the user may have on his laptop or desktop computer.

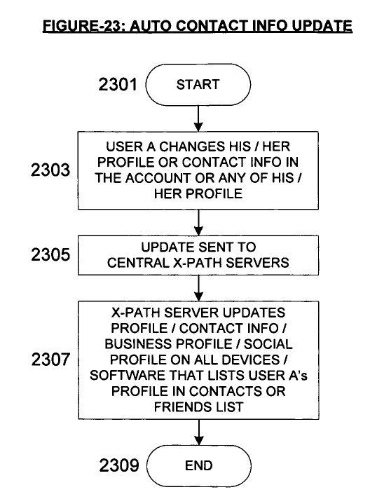

Auto-updating contact details in profiles of contacts and friends listed in the user's profile is an attractive feature of the device. In FIG. 23, the user updates the contact information 2303, for example, email id or mobile number in any of his/her user profile. This information is sent to the X-Path server 2305, which in turn automatically pushes the user's updated contact details in the address books of all other users who have the user listed in the Address Book or in the Friends List 2307.

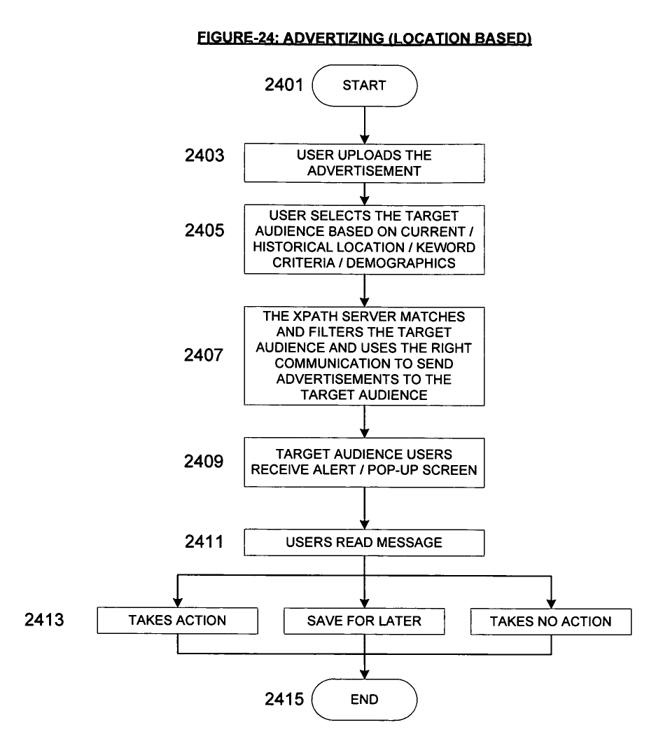

The device enables businesses to automatically broadcast messages to all available users entering the defined proximity. This feature is termed as proximity marketing and is useful to advertise new products, offers, discounts, and others messages. In FIG. 24, the business user uploads the advertisement utilizing the Internet to the X-Path server using his/her account login/password 2403. The business user then needs to define his/her target audience based on the current or historical locations, keywords, or demographics 2405. The x-path server actively maintains a real-time database of all the users, their current location and their historical locations (places they have visited in the past). The x-path server also matches the keywords or the demographic requirements that the business user has used to define his target audience with the profile information of all its users in the defined Scan Radius. As soon as any of the required criteria (location, historical location, demographics, interest, keywords etc) are met in the defined Scan Radius; the device using the right communication 2407 and broadcasts the advertisement as a pop-up on the device's display screen 2409. The target user can read the message 2411 and take the desired action (respond to the advertisement, save it for future or take no action) 2413.

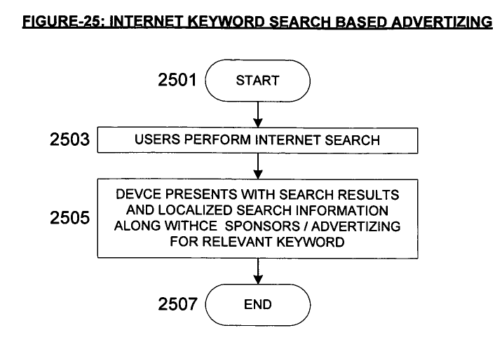

In FIG. 25, the device's inbuilt web browser enables users to perform an internet search 2503. As the user enters the keyword in an internet search engine, the browser displays the search results and advertisements relevant to the keyword and the location of the user 2505. For instance, if a user is in a shopping mall and searches for apparels, the browser displays all related links and links of various apparel advertisers in the shopping mall.

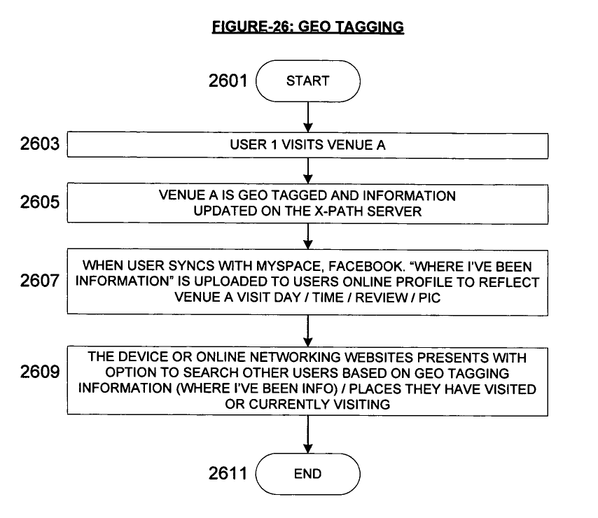

In FIG. 26, as user 1 visits a location or a venue (Point of Interest) 2603, the device's inbuilt GPS system tags the users current location, stores its details including date and time stamp and uploads it to the X-path server 2605 (if no internet connectivity is available at the given time. This information is then stored within the device and uploaded next time the device has internet connectivity and hence connectivity to the x-path server). Using this information stored on the x-path server, a user can search for all users who have visited the XYZ night club, the users can also be segregated by the date on which they visited the night club, and hence find people with similar interests or who were at the same location at the same time and hence have more in common with the people they find. A user can also search for users who are currently at a defined location/venue. The user can also opt to upload and syncs the information with a social networking site, this information is uploaded on the user's online social networking profile 2607, through this the user can let others know of the venue/places that he/she has visited or is currently at. It is this feature of the device that enables a user/business to define the target audience based on Current Geographical Location or Historical locations. Then the device or online networking websites presents with option to search other users based on geo tagging information (Where I've Been Info)/places they have visited or currently visiting 2609.

Locate Users: The device enables a user to locate a friend listed in his/her profile. The feature utilizes GPS in combination with other communication technology to locate friend on a map.

Direction to User: The device enables a user to identify directions to reach a friend listed in his/profile. The feature utilizes GPS in combination with other communication technology to present directions to reach a friend using a map.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, various elements or components may be combined or integrated in another system or certain features may be omitted, or not implemented.

Also, techniques, systems, sub-systems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other example of changes, substitutions, and alterations are ascertainable by one skilled in the art and could be made without departing from the scope disclosed herein.

More information about such wireless devices and telecommunications technology can be found in U.S. patent application Ser. No. 12/497,854, titled “System and Method for Pushing Data to a Mobile Device,” in U.S. patent application Ser. No. 12/495,909, titled “System And Methods For Facilitating Instant Communications Over Distributed Cellular Networks,” in U.S. patent application Ser. No. 12/397,733, titled “PROVISIONING MOBILE DEVICES BASED ON A CARRIER PROFILE,” in U.S. Pat. No. 7,649,744, titled “Handheld computing device,” in U.S. patent application Ser. No. 11/966,948, titled “MULTI-FUNCTIONAL HAND-HELD DEVICE,” in U.S. patent application Ser. No. 12/491,968, titled “Method For Transitioning Between Multiple Reception Levels,” in U.S. patent application Ser. No. 12/347,549, titled “Data Transferring Method And Content Transferring Method,” in U.S. patent application Ser. No. 12/375,793, titled “RF RECEIVER AND RFID/USN SYSTEM HAVING THE SAME,” in U.S. patent application Ser. No. 12/506,055, titled “LOCAL AND WIDE-AREA TRANSMISSIONS IN A WIRELESS BROADCAST NETWORK,” in U.S. patent application Ser. No. 12/433,845, titled “METHODS AND APPARATUS FOR COMMUNICATING TRANSMITTER INFORMATION IN A COMMUNICATION NETWORK,” in U.S. patent application Ser. No. 11/785,429, titled “Electronic device,” in U.S. patent application Ser. No. 12/143,820, titled “MOBILE COMMUNICATION DEVICE WITH GRAPHICAL USER INTERFACE TO ENABLE ACCESS TO PORTAL SERVICES,” in U.S. patent application Ser. No. 12/060,771, titled “METHOD AND SYSTEM FOR PROVISIONING A WIRELESS DEVICE,” in U.S. patent application Ser. No. 11/725,960, titled “FACILITATING USE OF A DEVICE BASED ON SHORT-RANGE WIRELESS TECHNOLOGY,” of which are incorporated herein by reference in their entirety.

A computer implemented method for providing point of interests networking and marketing from a first user to target users on wireless devices, the method comprising:
Receiving from the first user at the X-path server or user's wireless device the user profile;
Creating at least one broadcast message at the X-path server, user's wireless device, computer or web portal;
Setting criteria for message reception and broadcast on the user's wireless device, computer, X-path server or web portal;
Setting first user predetermined broadcast and reception range on the user's wireless device, X-Path server, computer, or web portal;
Selecting at least one telecommunications technology for each specific range by said wireless device or X-Path server;
Sending and receiving broadcast signals through a cellular network or through a direct wireless connection between wireless devices;
Scanning target user's profiles for user criteria fulfillment;
Receiving target user's information;
Analyzing said information for criteria matching;
Broadcasting at least one social or marketing message to one or more target users within a specified vicinity or proximity to said first user whom fulfill said first user broadcast criteria;
Alerting the target user upon matching message criteria of the broadcast message from the first user and
Receiving a reply from said target user.

A computer implemented method wherein said computer implemented method is utilized for business purposes. A computer implemented method wherein said first user is a merchant. A computer implemented method wherein said merchant broadcasts messages from either a wireless device or the X-path Server. A computer implemented method as in claim 4 wherein said merchant utilizes criteria to broadcast target marketing messages. A computer implemented method wherein said broadcast criteria is received from either the target user's wireless device or from the X-path server. A computer implemented method wherein said criteria is based on geo-tagging information, historical or current locations visited by target users. A computer implemented method wherein said broadcast criteria is the target user's salary, age, sex, experience, profession, work location, vacation trips, travel plans, marriage status, commuter, user's word cloud, or automobile owner. A computer implemented method wherein said criteria is location targeting. A computer implemented method wherein said message is a offer of promotional, sales or discount information for target users within a specified physical vicinity of a merchant's store. A computer implemented method wherein said promotion includes the merchant allocating a predetermined number of target users to complete a task prior to receiving said promotion. A computer implemented method wherein said task includes purchasing a certain item or entering the store prior to a predetermined time frame. A computer implemented method as in claim 10 wherein said sales item is loss-leader merchandise. A computer implemented method wherein said task includes a merchant questionnaire. A computer implemented method wherein said message is job postings. A computer implemented method wherein said message is a personal item for sale. A computer implemented method wherein said personal item is used car, computer, used clothes, antiques or collectables. A computer implemented method wherein said message is general advertising for target users within a predetermined vicinity to the first user. A computer implemented method wherein said message is directed marketing for target users with a specific profile details within a predetermined vicinity to the first user. A computer implemented method wherein said specific profile details which include user profession, likes, current or historical locations visited. A computer implemented method wherein said broadcast criteria is based upon the target user's location information, either historical location visited, frequently visited locations or the current location of the target user, received from either the target user's wireless device or the target user's profile data residing on the X-path server. A computer implemented method wherein said target user is notified by said wireless device of message satisfying reception criteria set by the target user or logging said messages for access by the target user at a later time. A computer implemented method wherein said offer and sale is completed solely on the target user's wireless device without the need for physical interaction between users. A computer implemented method wherein said broadcast criteria is set to business meeting or networking event. A computer implemented method wherein said localized message is information contained on a business card or the user's resume. A computer implemented method wherein said computer implemented method is utilized for personal purposes. A computer implemented method wherein said first user is focused on finding new friends or romantic relationships based upon predefined criteria. A computer implemented method wherein said first user's broadcast criteria are sex, Geo-Tag information, word cloud, friend cloud, common interest, sexual orientation, race, hair color, height, favorite locations and profession. A computer implemented method wherein said predefined criteria is common friends or contacts of both the first user and the target user. A computer implemented method wherein said first user's broadcast are predetermined to find matching target users based upon target locations that the target users are visiting or have visited. A computer implemented method wherein said first user's broadcast are predetermined to find matching target users within the same building, neighborhood or relative vicinity. A computer implemented method wherein sending messages to matching target users. A computer implemented method wherein said messages include a predetermined greeting, picture, or request for anonymous contact. A computer implemented method wherein said messages satisfy said target user's predefined reception criteria, said user is notified of the message for viewing or viewing at a later date. A computer implemented method wherein said contact comprises: instant messaging, text messaging, tweeting, MMS, phone call, friend request, voice message or video conference. A computer implemented method wherein said completion of initial contact, the first user and target user may choose to meet in person or exchange of personal information. A computer implemented method wherein said personal information includes a phone number, email address, facebook profile, add friend request or residential address. A computer implemented method wherein limited range broadcasts and reception comprise of Bluetooth, Near Field Communications, Transferjet, WLAN, infrared signals, radio waves, and microwave signals. A computer implemented method wherein long range broadcasts and reception comprise of GSM, 2G, 3G, 4G, GPRS, HSPA, HSUPA, HSDPA, CDMA, UMTS, WiMAX, and WiBro. A computer implemented method wherein said wireless device comprise of a portable computer, Iphone, cellular phone, smart phone, personal digital assistant, laptop, iPad, tablet PC and netbook. A computer implemented method wherein said first user may manually initiate a proximity scan to locate target users of interest. A computer implemented method wherein said target user information is synced onto the X-path server, social networking websites, database, or address management system. A computer implemented method wherein said scanning of proximity of target users comprises: GPS, WiFi, Bluetooth, 3G, cellular triangulation, AGPS, and X-path server information. A computer implemented method wherein criteria matching of the first user and target user consist of comparison of each user's word cloud keywords. A computer implemented method wherein said X-path server logs all locations visited by the user. A computer implemented method wherein said target user X-path server information or device information is synced to the user's social networking websites. A computer implemented method wherein criteria matching of the first user and target user, location data is provided to users. A computer implemented method wherein first user and target user communication is carried over either a wireless cellular network or routed directly between the first user's device and the target user's device without the use of an external network.

A computer implemented method for providing point of interests networking and marketing from a first user to target users on wireless devices, the method comprising:
Receiving from the first user at the X-path server or user's wireless device the user profile;
Tracking and logging all locations visited by users on either the wireless device or the X-path server;
Creating at least one broadcast message at the X-path server, user's wireless device, computer, or web portal;
Setting criteria for message reception and broadcast on the user's wireless device, X-Path server, computer, or web portal;
Said broadcast criteria is the current or past locations visited by the target user;
Setting first user predetermined broadcast and reception range on the user's wireless device, X-Path server, computer or web portal;
Selecting at least one telecommunications technology for each specific range by said wireless device or X-Path server;
Sending and receiving broadcast signals through a cellular network or through a direct wireless connection between wireless devices;
Scanning target user's profiles for user criteria fulfillment;
Receiving target user's information on device or X-Path server;
Analyzing said information for criteria matching;
Broadcasting at least one social or marketing message to one or more target users within a specified vicinity or proximity to said first user whom fulfill said first user broadcast criteria;
Alerting the target user upon matching message criteria of the broadcast message from the first user and
Receiving a reply from said target user.

A computer implemented method wherein said computer implemented method is utilized for business purposes. A computer implemented method wherein said first user is a merchant. A computer implemented method wherein said merchant broadcasts messages from either a wireless device or the X-path Server. A computer implemented method as in claim 4 wherein said merchant utilizes criteria to broadcast target marketing messages. A computer implemented method wherein said broadcast criteria is received from either the target user's wireless device or from the X-path server. A computer implemented method wherein said criteria is based on geo-tagging information, historical or current locations visited by target users. A computer implemented method wherein said broadcast criteria is the target user's salary, age, sex, experience, profession, work location, vacation trips, travel plans, marriage status, commuter, user's word cloud, or automobile owner. A computer implemented method wherein said criteria is location targeting. A computer implemented method wherein said message is a offer of promotional, sales or discount information for target users within a specified physical vicinity of a merchant's store. A computer implemented method wherein said promotion includes the merchant allocating a predetermined number of target users to complete a task prior to receiving said promotion. A computer implemented method wherein said task includes purchasing a certain item or entering the store prior to a predetermined time frame. A computer implemented method as in claim 10 wherein said sales item is loss-leader merchandise. A computer implemented method wherein said task includes a merchant questionnaire. A computer implemented method wherein said message is job postings. A computer implemented method wherein said message is a personal item for sale. A computer implemented method wherein said personal item is used car, computer, used clothes, antiques or collectables. A computer implemented method wherein said message is general advertising for target users within a predetermined vicinity to the first user. A computer implemented method wherein said message is directed marketing for target users with a specific profile details within a predetermined vicinity to the first user. A computer implemented method wherein said specific profile details which include user profession, likes, current or historical locations visited. A computer implemented method wherein said broadcast criteria is based upon the target user's location information, either historical location visited, frequently visited locations or the current location of the target user, received from either the target user's wireless device or the target user's profile data residing on the X-path server. A computer implemented method wherein said target user is notified by said wireless device of message satisfying reception criteria set by the target user or logging said messages for access by the target user at a later time. A computer implemented method wherein said offer and sale is completed solely on the target user's wireless device without the need for physical interaction between users. A computer implemented method wherein said broadcast criteria is set to business meeting or networking event. A computer implemented method wherein said localized message is information contained on a business card or the user's resume. A computer implemented method wherein said computer implemented method is utilized for personal purposes. A computer implemented method wherein said first user is focused on finding new friends or romantic relationships based upon predefined criteria. A computer implemented method wherein said first user's broadcast criteria are sex, Geo-Tag information, word cloud, friend cloud, common interest, sexual orientation, race, hair color, height, favorite locations and profession. A computer implemented method wherein said predefined criteria is common friends or contacts of both the first user and the target user. A computer implemented method wherein said first user's broadcast are predetermined to find matching target users based upon target locations that the target users are visiting or have visited. A computer implemented method wherein said first user's broadcast are predetermined to find matching target users within the same building, neighborhood or relative vicinity. A computer implemented method wherein sending messages to matching target users. A computer implemented method wherein said messages include a predetermined greeting, picture, or request for anonymous contact. A computer implemented method wherein said messages satisfy said target user's predefined reception criteria, said user is notified of the message for viewing or viewing at a later date. A computer implemented method wherein said contact comprises: instant messaging, text messaging, tweeting, MMS, phone call, friend request, voice message or video conference. A computer implemented method wherein said completion of initial contact, the first user and target user may choose to meet in person or exchange of personal information. A computer implemented method wherein said personal information includes a phone number, email address, facebook profile, add friend request or residential address. A computer implemented method wherein limited range broadcasts and reception comprise of Bluetooth, Near Field Communications, Transferjet, WLAN, infrared signals, radio waves, and microwave signals. A computer implemented method wherein long range broadcasts and reception comprise of GSM, 2G, 3G, 4G, GPRS, HSPA, HSUPA, HSDPA, CDMA, UMTS, WiMAX, and WiBro. A computer implemented method wherein said wireless device comprise of a portable computer, Iphone, cellular phone, smart phone, personal digital assistant, laptop, iPad, tablet PC and netbook. A computer implemented method wherein said first user may manually initiate a proximity scan to locate target users of interest. A computer implemented method wherein said target user information is synced onto the X-path server, social networking websites, database, or address management system. A computer implemented method wherein said scanning of proximity of target users comprises: GPS, WiFi, Bluetooth, 3G, cellular triangulation, AGPS, and X-path server information. A computer implemented method wherein criteria matching of the first user and target user consist of comparison of each user's word cloud keywords. A computer implemented method wherein said X-path server logs all locations visited by the user. A computer implemented method wherein said target user X-path server information or device information is synced to the user's social networking websites. A computer implemented method wherein criteria matching of the first user and target user, location data is provided to users. A computer implemented method wherein first user and target user communication is carried over either a wireless cellular network or routed directly between the first user's device and the target user's device without the use of an external network.

A computer implemented method for providing point of interests networking and marketing from a first user to target users on wireless devices, the method comprising:
Receiving from the first user at the X-path server or user's wireless device the user profile;
Creating at least one broadcast message at the X-path server, user's wireless device, computer, or web portal;
Setting criteria for message reception and broadcast on the user's wireless device, X-Path server, computer, or web portal;
Matching broadcast or reception criteria based upon words residing in each user's word cloud;
Setting first user predetermined broadcast and reception range on the user's wireless device, X-Path server, computer, or web portal;
Selecting at least one telecommunications technology for each specific range by said wireless device or X-Path server;
Sending and receiving broadcast signals through a cellular network or through a direct wireless connection between wireless devices;
Scanning target user's profiles for user criteria fulfillment;
Receiving target user's information;
Analyzing said information for criteria matching;
Broadcasting at least one social or marketing message to one or more target users within a specified vicinity or proximity to said first user whom fulfill said first user broadcast criteria;
Alerting the target user upon matching message criteria of the broadcast message from the first user and
Receiving a reply from said target user.

A computer implemented method wherein said computer implemented method is utilized for business purposes. A computer implemented method wherein said first user is a merchant. A computer implemented method wherein said merchant broadcasts messages from either a wireless device or the X-path Server. A computer implemented method as in claim 4 wherein said merchant utilizes criteria to broadcast target marketing messages. A computer implemented method wherein said broadcast criteria is received from either the target user's wireless device or from the X-path server. A computer implemented method wherein said criteria is based on geo-tagging information, historical or current locations visited by target users. A computer implemented method wherein said broadcast criteria is the target user's salary, age, sex, experience, profession, work location, vacation trips, travel plans, marriage status, commuter, user's word cloud, or automobile owner. A computer implemented method wherein said criteria is location targeting. A computer implemented method wherein said message is a offer of promotional, sales or discount information for target users within a specified physical vicinity of a merchant's store. A computer implemented method wherein said promotion includes the merchant allocating a predetermined number of target users to complete a task prior to receiving said promotion. A computer implemented method wherein said task includes purchasing a certain item or entering the store prior to a predetermined time frame. A computer implemented method as in claim 10 wherein said sales item is loss-leader merchandise. A computer implemented method wherein said task includes a merchant questionnaire. A computer implemented method wherein said message is job postings. A computer implemented method wherein said message is a personal item for sale. A computer implemented method wherein said personal item is used car, computer, used clothes, antiques or collectables. A computer implemented method wherein said message is general advertising for target users within a predetermined vicinity to the first user. A computer implemented method wherein said message is directed marketing for target users with a specific profile details within a predetermined vicinity to the first user. A computer implemented method wherein said specific profile details which include user profession, likes, current or historical locations visited. A computer implemented method wherein said broadcast criteria is based upon the target user's location information, either historical location visited, frequently visited locations or the current location of the target user, received from either the target user's wireless device or the target user's profile data residing on the X-path server. A computer implemented method wherein said target user is notified by said wireless device of message satisfying reception criteria set by the target user or logging said messages for access by the target user at a later time. A computer implemented method wherein said offer and sale is completed solely on the target user's wireless device without the need for physical interaction between users. A computer implemented method wherein said broadcast criteria is set to business meeting or networking event. A computer implemented method wherein said localized message is information contained on a business card or the user's resume. A computer implemented method wherein said computer implemented method is utilized for personal purposes. A computer implemented method wherein said first user is focused on finding new friends or romantic relationships based upon predefined criteria. A computer implemented method wherein said first user's broadcast criteria are sex, Geo-Tag information, word cloud, friend cloud, common interest, sexual orientation, race, hair color, height, favorite locations and profession. A computer implemented method wherein said predefined criteria is common friends or contacts of both the first user and the target user. A computer implemented method wherein said first user's broadcast are predetermined to find matching target users based upon target locations that the target users are visiting or have visited. A computer implemented method wherein said first user's broadcast are predetermined to find matching target users within the same building, neighborhood or relative vicinity. A computer implemented method wherein sending messages to matching target users. A computer implemented method wherein said messages include a predetermined greeting, picture, or request for anonymous contact. A computer implemented method wherein said messages satisfy said target user's predefined reception criteria, said user is notified of the message for viewing or viewing at a later date. A computer implemented method wherein said contact comprises: instant messaging, text messaging, tweeting, MMS, phone call, friend request, voice message or video conference. A computer implemented method wherein said completion of initial contact, the first user and target user may choose to meet in person or exchange of personal information. A computer implemented method wherein said personal information includes a phone number, email address, facebook profile, add friend request or residential address. A computer implemented method wherein limited range broadcasts and reception comprise of Bluetooth, Near Field Communications, Transferjet, WLAN, infrared signals, radio waves, and microwave signals. A computer implemented method wherein long range broadcasts and reception comprise of GSM, 2G, 3G, 4G, GPRS, HSPA, HSUPA, HSDPA, CDMA, UMTS, WiMAX, and WiBro. A computer implemented method wherein said wireless device comprise of a portable computer, Iphone, cellular phone, smart phone, personal digital assistant, laptop, iPad, tablet PC and netbook. A computer implemented method wherein said first user may manually initiate a proximity scan to locate target users of interest. A computer implemented method wherein said target user information is synced onto the X-path server, social networking websites, database, or address management system. A computer implemented method wherein said scanning of proximity of target users comprises: GPS, WiFi, Bluetooth, 3G, cellular triangulation, AGPS, and X-path server information. A computer implemented method wherein criteria matching of the first user and target user consist of comparison of each user's word cloud keywords. A computer implemented method wherein said X-path server logs all locations visited by the user. A computer implemented method wherein said target user X-path server information or device information is synced to the user's social networking websites. A computer implemented method wherein criteria matching of the first user and target user, location data is provided to users. A computer implemented method wherein first user and target user communication is carried over either a wireless cellular network or routed directly between the first user's device and the target user's device without the use of an external network.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below

I claim:

1. A computer implemented method for providing point of interests networking and marketing from a first user to target users on wireless devices, the method comprising:
a. Receiving from the first user at the X-path server or user's wireless device the user profile;
b. Creating at least one broadcast message at the X-path server, user's wireless device, computer or web portal;
c. Setting criteria for message reception and broadcast on the user's wireless device, computer, X-path server or web portal;
d. Setting first user predetermined broadcast and reception range on the user's wireless device, X-Path server, computer, or web portal;
e. Selecting at least one telecommunications technology for each specific range by said wireless device or X-Path server;
f. Sending and receiving broadcast signals through a cellular network or through a direct wireless connection between wireless devices;
g. Scanning target user's profiles for user criteria fulfillment;
h. Receiving target user's information;
i. Analyzing said information for criteria matching;
j. Broadcasting at least one social or marketing message to one or more target users within a specified vicinity or proximity to said first user whom fulfill said first user broadcast criteria;
k. Alerting the target user upon matching message criteria of the broadcast message from the first user and
l. Receiving a reply from said target user.

2. A computer implemented method as in claim 1 wherein said computer implemented method is utilized for business purposes.

3. A computer implemented method as in claim 2 wherein said first user is a merchant.

4. A computer implemented method as in claim 3 wherein said merchant broadcasts messages from either a wireless device or the X-path Server.

5. A computer implemented method as in claim 4 wherein said merchant utilizes criteria to broadcast target marketing messages.

6. A computer implemented method as in claim 5 wherein said broadcast criteria is received from either the target user's wireless device or from the X-path server.

7. A computer implemented method as in claim 5 wherein said criteria is based on geo-tagging information, historical or current locations visited by target users.

8. A computer implemented method as in claim 5 wherein said broadcast criteria is the target user's salary, age, sex, experience, profession, work location, vacation trips, travel plans, marriage status, commuter, user's word cloud, or automobile owner.

9. A computer implemented method as in claim 5 wherein said criteria is location targeting.

10. A computer implemented method as in claim 4 wherein said message is a offer of promotional, sales or discount information for target users within a specified physical vicinity of a merchant's store.

11. A computer implemented method as in claim 10 wherein said promotion includes the merchant allocating a predetermined number of target users to complete a task prior to receiving said promotion.

12. A computer implemented method as in claim 11 wherein said task includes purchasing a certain item or entering the store prior to a predetermined time frame.

13. A computer implemented method as in claim 10 wherein said sales item is loss-leader merchandise.

14. A computer implemented method as in claim 11 wherein said task includes a merchant questionnaire.

15. A computer implemented method as in claim 2 wherein said message is job postings.

16. A computer implemented method as in claim 2 wherein said message is a personal item for sale.

17. A computer implemented method as in claim 16 wherein said personal item is used car, computer, used clothes, antiques or collectables.

18. A computer implemented method as in claim 16 wherein said message is general advertising for target users within a predetermined vicinity to the first user.

19. A computer implemented method as in claim 2 wherein said message is directed marketing for target users with a specific profile details within a predetermined vicinity to the first user.

20. A computer implemented method as in claim 19 wherein said specific profile details which include user profession, likes, current or historical locations visited.

21. A computer implemented method as in claim 5 wherein said broadcast criteria is based upon the target user's location information, either historical location visited, frequently visited locations or the current location of the target user, received from either the target user's wireless device or the target user's profile data residing on the X-path server.

22. A computer implemented method as in claim 2 wherein said target user is notified by said wireless device of message satisfying reception criteria set by the target user or logging said messages for access by the target user at a later time.

23. A computer implemented method as in claim 10 wherein said offer and sale is completed solely on the target user's wireless device without the need for physical interaction between users.

24. A computer implemented method as in claim 2 wherein said broadcast criteria is set to business meeting or networking event.

25. A computer implemented method as in claim 24 wherein said localized message is information contained on a business card or the user's resume.

26. A computer implemented method as in claim 1 wherein said computer implemented method is utilized for personal purposes.

27. A computer implemented method as in claim 26 wherein said first user is focused on finding new friends or romantic relationships based upon predefined criteria.

28. A computer implemented method as in claim 27 wherein said first user's broadcast criteria are sex, Geo-Tag information, word cloud, friend cloud, common interest, sexual orientation, race, hair color, height, favorite locations and profession.

29. A computer implemented method as in claim 27 wherein said predefined criteria is common friends or contacts of both the first user and the target user.

30. A computer implemented method as in claim 2 wherein said first user's broadcast are predetermined to find matching target users based upon target locations that the target users are visiting or have visited.

31. A computer implemented method as in claim 27 wherein said first user's broadcast are predetermined to find matching target users within the same building, neighborhood or relative vicinity.

32. A computer implemented method as in claim 27 wherein sending messages to matching target users.

33. A computer implemented method as in claim 32 wherein said messages include a predetermined greeting, picture, or request for anonymous contact.

34. A computer implemented method as in claim 33 wherein said messages satisfy said target user's predefined reception criteria, said user is notified of the message for viewing or viewing at a later date.

35. A computer implemented method as in claim 32 wherein said contact comprises: instant messaging, text messaging, tweeting, MMS, phone call, friend request, voice message or video conference.

36. A computer implemented method as in claim 35 wherein said completion of initial contact, the first user and target user may choose to meet in person or exchange of personal information.

37. A computer implemented method as in claim 36 wherein said personal information includes a phone number, email address, facebook profile, add friend request or residential address.

38. A computer implemented method as in claim 1 wherein limited range broadcasts and reception comprise of Bluetooth, Near Field Communications, Transferjet, WLAN, infrared signals, radio waves, and microwave signals.

39. A computer implemented method as in claim 1 wherein long range broadcasts and reception comprise of GSM, 2G, 3G, 4G, GPRS, HSPA, HSUPA, HSDPA, CDMA, UMTS, WiMAX, and WiBro.

40. A computer implemented method as in claim 1 wherein said wireless device comprise of a portable computer, Iphone, cellular phone, smart phone, personal digital assistant, laptop, iPad, tablet PC and netbook.

41. A computer implemented method as in claim 1 wherein said first user may manually initiate a proximity scan to locate target users of interest.

42. A computer implemented method as in claim 1 wherein said target user information is synced onto the X-path server, social networking websites, database, or address management system.

43. A computer implemented method as in claim 1 wherein said scanning of proximity of target users comprises: GPS, WiFi, Bluetooth, 3G, cellular triangulation, AGPS, and X-path server information.

44. A computer implemented method as in claim 1 wherein criteria matching of the first user and target user consist of comparison of each user's word cloud keywords.

45. A computer implemented method as in claim 1 wherein said X-path server logs all locations visited by the user.

46. A computer implemented method as in claim 1 wherein said target user X-path server information or device information is synced to the user's social networking websites.

47. A computer implemented method as in claim 1 wherein criteria matching of the first user and target user, location data is provided to users.

48. A computer implemented method as in claim 1 wherein first user and target user communication is carried over either a wireless cellular network or routed directly between the first user's device and the target user's device without the use of an external network.

49. A computer implemented method for providing point of interests networking and marketing from a first user to target users on wireless devices, the method comprising:
a. Receiving from the first user at the X-path server or user's wireless device the user profile;
b. Tracking and logging all locations visited by users on either the wireless device or the X-path server;
c. Creating at least one broadcast message at the X-path server, user's wireless device, computer, or web portal;
d. Setting criteria for message reception and broadcast on the user's wireless device, X-Path server, computer, or web portal;
e. Said broadcast criteria is the current or past locations visited by the target user;
f. Setting first user predetermined broadcast and reception range on the user's wireless device, X-Path server, computer or web portal;
g. Selecting at least one telecommunications technology for each specific range by said wireless device or X-Path server;
h. Sending and receiving broadcast signals through a cellular network or through a direct wireless connection between wireless devices;
i. Scanning target user's profiles for user criteria fulfillment;
j. Receiving target user's information on device or X-Path server;
k. Analyzing said information for criteria matching;
l. Broadcasting at least one social or marketing message to one or more target users within a specified vicinity or proximity to said first user whom fulfill said first user broadcast criteria;
m. Alerting the target user upon matching message criteria of the broadcast message from the first user and
n. Receiving a reply from said target user.

50. A computer implemented method for providing point of interests networking and marketing from a first user to target users on wireless devices, the method comprising:
a. Receiving from the first user at the X-path server or user's wireless device the user profile;
b. Creating at least one broadcast message at the X-path server, user's wireless device, computer, or web portal;
c. Setting criteria for message reception and broadcast on the user's wireless device, X-Path server, computer, or web portal;
d. Matching broadcast or reception criteria based upon words residing in each user's word cloud;
e. Setting first user predetermined broadcast and reception range on the user's wireless device, X-Path server, computer, or web portal;
f. Selecting at least one telecommunications technology for each specific range by said wireless device or X-Path server;
g. Sending and receiving broadcast signals through a cellular network or through a direct wireless connection between wireless devices;
h. Scanning target user's profiles for user criteria fulfillment;
i. Receiving target user's information;
j. Analyzing said information for criteria matching;
k. Broadcasting at least one social or marketing message to one or more target users within a specified vicinity or proximity to said first user whom fulfill said first user broadcast criteria;
l. Alerting the target user upon matching message criteria of the broadcast message from the first user and
m. Receiving a reply from said target user.
